(19) United States
(12) Patent Application Publication
(10) Pub. No.: US 2023/0386138 A1
(43) Pub. Date: Nov. 30, 2023

(54) VIRTUAL ENVIRONMENTS FOR AUTONOMOUS VEHICLE PASSENGERS

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/828,506

(22) Filed: May 31, 2022

(51) Int. Cl. G06T 19/00; G06T 13/20; B60W 40/08; B60W 60/00

(52) U.S. Cl. CPC G06T 19/00; G06T 13/20; B60W 40/08; B60W 60/001

(57) ABSTRACT

Users getting rides in AVs can engage in virtual environments through client devices (e.g., headsets, etc.) that project the virtual environments to the users. A user may perceive a virtual environment and engage in the virtual environment during a ride in an AV. The virtual environment includes a virtual scene generated based on the ride in the AV or an interaction of the user with another person in the real-world. The virtual scene includes a virtual representation of the user and other virtual objects. A virtual object may be generated based on an object, a behavior of the AV, or an activity of the user in the real-world. The user may perform various virtual activities in the virtual environment, such as communications with other users, digital interactive experiences, etc. A behavior of the AV (e.g., the AV's navigation) may be changed based on a virtual activity of the user.

### TECHNICAL FIELD OF THE DISCLOSURE

The present disclosure relates generally to autonomous vehicles (AVs) and, more specifically, to virtual environments for AV passengers.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can project virtual scenes to passengers;

FIG. 2 is a block diagram showing a sensor suite, according to some embodiments of the present disclosure;

FIG. 3 is a block diagram showing a fleet management system, according to some embodiments of the present disclosure;

FIG. 4 is a block diagram showing an onboard computer, according to some embodiments of the present disclosure;

FIG. 5A illustrates a real-world environment in which a user has a ride in an AV;

FIG. 5B illustrates a virtual scene projected to the user in the AV;

FIG. 6 is a flowchart showing a method of projecting a virtual scene to an AV passenger, according to some embodiments of the present disclosure; and

FIG. 7 is a flowchart showing another method of projecting a virtual scene to an AV passenger, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless ride services. A person can request an AV to pick him/her up from a location and drop him/her off at another location. With the autonomous driving features of the AV, the person does not need to drive during the ride and can take the time to engage in other activities, such as communication, entertainment, training, work, and so on.

Embodiments of the present disclosure provides a virtual environment platform for providing virtual environments and virtual environment enhanced real-world experiences to passengers of AVs. A virtual environment is a computer-generated virtual representation of a three-dimensional (3D) space. A virtual environment may be a virtual reality (VR), augmented reality (AR), or mixed reality (MR) environment. A user, such as a passenger of an AV, may engage in the virtual environment via a virtual representation (e.g., avatars) of himself or herself. Through the virtual representation, the user can perceive himself or herself as existing within the virtual environment and can engage in the virtual environment. The user can make changes to the virtual environment, and such changes can be perceived by other users. The user's engagement in the virtual environment may be facilitated through a client device that connects the user to the virtual environment. The client device may be a headset (e.g., a VR, AR, or MR headset), a phone, a tablet, a computer, or other device. The user can perceive (e.g., see, hear, smell, or feel) the virtual environment and perform virtual activities through the client device. A virtual activity is an activity of the virtual representation of the user in the virtual environment. Example virtual activities include virtual social activities (e.g., communications (e.g., chat, messaging, document sharing, etc.) with other people who also engage in the virtual environment), virtual entertainment activities (e.g., engaging in a digital interactive experience), virtual educational activities (e.g., participating in a training session held in the virtual environment), virtual work activities (e.g., joining a virtual conference with coworkers), and so on.

In some embodiments, an AV generates a virtual scene and provides the virtual scene to a client device of a passenger of the AV. The virtual scene may be a virtual environment or a part of a virtual environment with which the passenger can engage in. The AV may generate the virtual scene based on the ride, such as a real-world environment where the AV operates during the ride, operational behaviors of the AV during the ride, and so on. Additionally or alternatively, the AV can generate the virtual scene based on one or more activities of the passenger in the real-world, which may be detected by a sensor in the AV. The virtual scene may include virtual objects that represent the passenger, other passengers, other people, the AV, other AVs, other vehicles, or other objects. A virtual object may be dynamic or animated. A virtual object representing a real-world object may have features of the real-world object or additional features that the real-world object does not have. In some embodiments, the AV may connect the virtual scene with a virtual world (e.g., a metaverse) provided by a different system, and the passenger may engage in the virtual world.

The AV can modify the virtual scene based on a virtual activity. For instance, the AV may add an audio or video into the virtual scene based on a virtual conversation discussing the audio or video. The AV can also modify its operational behaviors based on a virtual activity. A navigation route of the AV can be changed based on a location indicated a virtual conversation of the passenger with another person in the virtual scene. For instance, the AV can travel to a location where the passenger will pick up the person or meet with the person. A behavior of the AV can also be changed to facilitate a virtual activity. For example, the AV may select or avoid a street in its navigation route so that the passenger can get the opportunity to interact with passengers of other AVs driving on the street. As another example, the AV may change its motion, and the perception of the AV's motion by the passenger can increase the amount of entertainment that a digital interactive experience can provide to the passenger.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example System for Projecting Virtual Scenes to AV Passengers

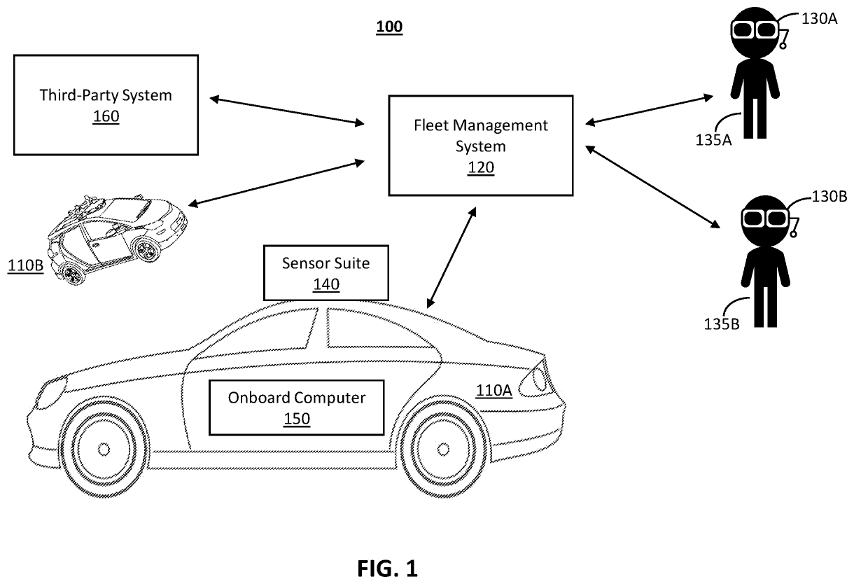

FIG. 1 illustrates a system 100 including a fleet of AVs that can project virtual scenes to passengers, according to some embodiments of the present disclosure. The system 100 includes AVs 110A and 110B (collectively referred to as “AVs 110” or “AV 110”), a fleet management system 120, client devices 130A and 130B (collectively referred to as “client devices 130” or “client device 130”), and a third-party system 160. The AV 110A includes a sensor suite 140 and an onboard computer 150. Even though not shown in FIG. 1, the 110B can also include a sensor suite 140 and an onboard computer 150. In other embodiments, the system 100 may include more, fewer, or different components. For example, the fleet of AVs may include more than two AVs 110 or more than two client devices 130. Also, the system 100 may include more than one third-party system 160.

The fleet management system 120 receives service requests for the AVs 110 from the client devices 130. The system environment may include various client devices, e.g., client device 130A and client device 130B, associated with different users 135, e.g., user 135A and 135B. For example, the user 135A accesses an app executing on the client device 130A and requests a ride from a pickup location (e.g., the current location of the client device 130A) to a destination location. The client device 130A transmits the ride request to the fleet management system 120. The fleet management system 120 selects an AV (e.g., AV 110A) from the fleet of AVs 110 and dispatches the selected AV 110A to the pickup location to carry out the ride request. In some embodiments, the ride request further includes a number of passengers in the group. In some embodiments, the ride request indicates whether a user 135 is interested in a shared ride with another user traveling in the same direction or along a same portion of a route. The ride request, or settings previously entered by the user 135, may further indicate whether the user 135 is interested in interaction with another passenger.

A client device 130 is a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, speakers, headphones, projectors, and so on. For example, the client device 130 includes a projector that can project virtual scene (e.g., three-dimensional (3D) virtual scene) to a user 135.

In various of embodiments, the client device 130 can present VR, AR, or MR to the user 135. For purpose of illustration, a client device 130 in FIG. 1 is a headset. In other embodiments, a client device 130 may be a different type of device, such as a desktop or a laptop computer, a smartphone, a mobile telephone, a personal digital assistant (PDA), or another suitable device. The client device 130 may be positioned on the user 135, or on the AV 110. The client device 130 may include components that facilitate virtual activities of the user 135 in a virtual environment. For instance, the client device 130 may include one or more speakers and microphones that enable the user 135 to make a virtual conversation, such as a conversation between an avatar representing the user 135 and an avatar representing another person. The client device 130 may also include controllers (e.g., handles, gloves, etc.) that the user 135 can use to control a virtual object the virtual scene. The client device 130, or a part of the client device 130, may be attached to the AV 110 or be a component of the AV 110. For instance, a projector of the client device 130 may be a projector fixed in the AV 110. In some embodiments, a user 135 may have multiple client devices 130 for different purpose. For instance, a user 135 may use a client device 130 to interact with the fleet management system 120, e.g., to request ride services, and use another client device 130 to get access to virtual scenes.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may make service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to delivery one or more items from a location to another location), and so on. The UI may allow users 135 to provide locations (e.g., pickup location, destination location, etc.) or other information that would be needed by AVs 110 to provide services requested by the users 135.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

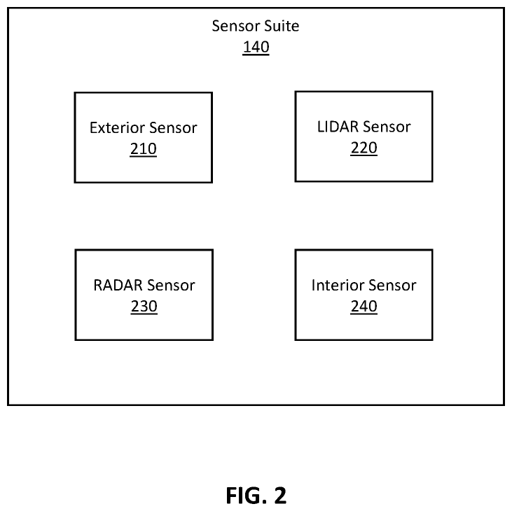

The AV 110 includes a sensor suite 140, which includes a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 2.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. In some embodiments, the onboard computer 150 can also receive sensor data from the sensor suite 140 and/or other sensors to determine a state of a user 135 in the AV 110, such as a gesture of the user 135, a communication involving the user 135, and so on. The onboard computer 150 may generate a virtual scene based on the state of the user and provide the virtual scene to a client device 130 that can present the virtual scene to the user 135.

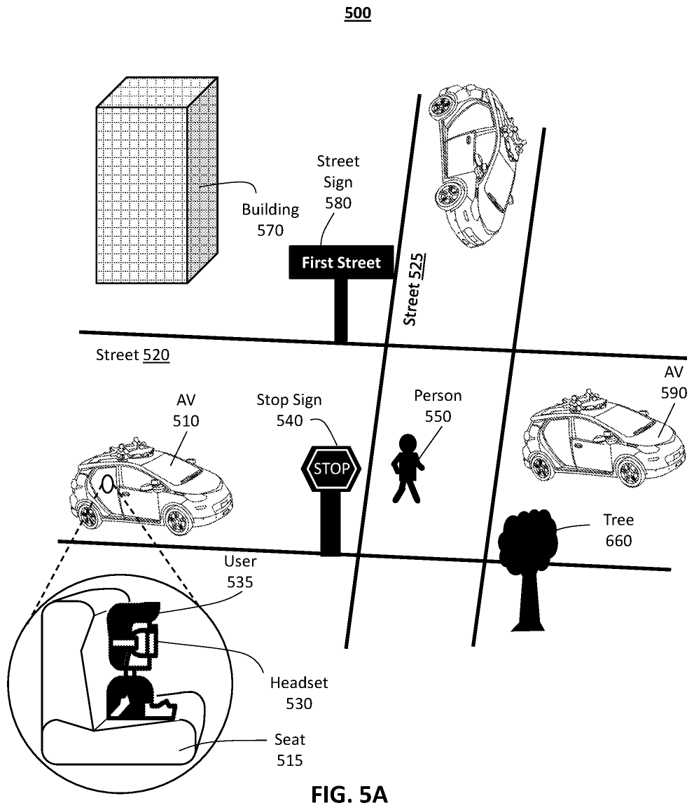

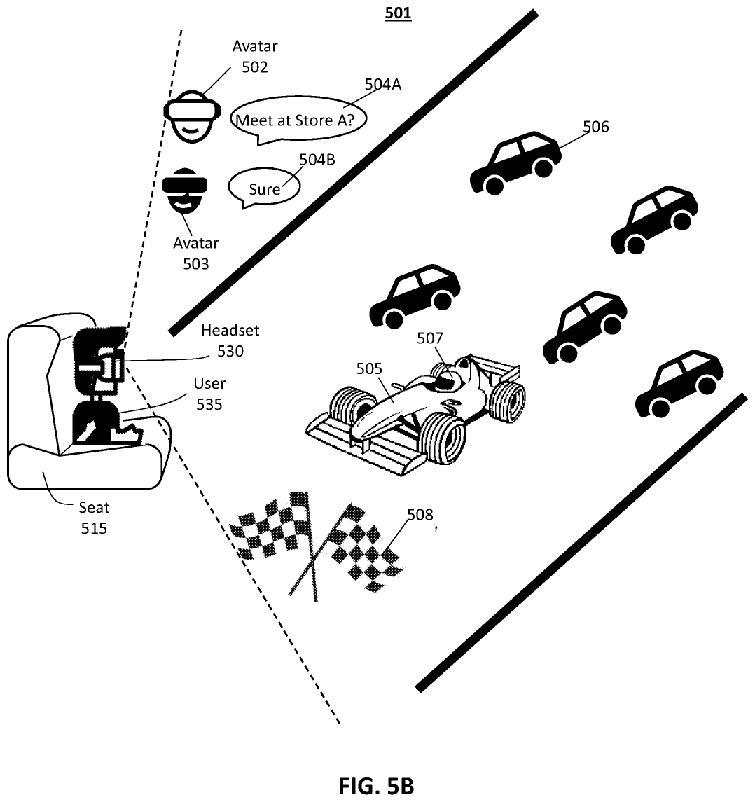

The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems. Certain aspects of the onboard computer 150 are described further in relation to FIG. 5.

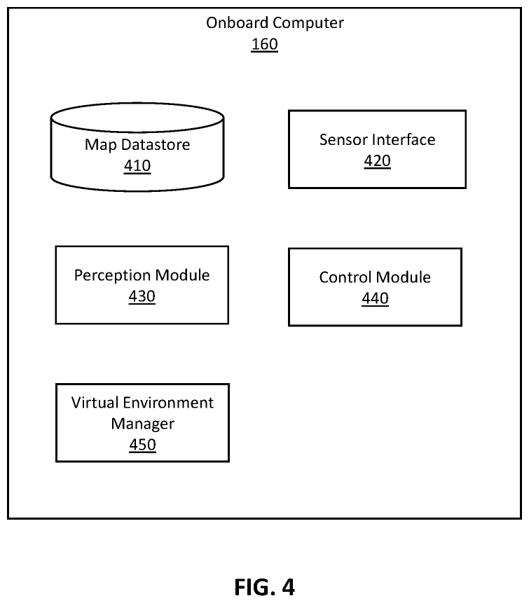

The fleet management system 120 manages the fleet of AVs 110. The fleet management system 120 may manage one or more services that provides or uses the AVs, e.g., a service for providing rides to users using the AVs. The fleet management system 120 selects one or more AVs (e.g., AV 110A) from a fleet of AVs 110 to perform a particular service or other task, and instructs the selected AV to drive to one or more particular location (e.g., a first address to pick up user 135a, and a second address to pick up user 135b). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a public network, such as the Internet. The fleet management system 120 is described further in relation to FIG. 4.

The third-party system 160 is in communication with the fleet management system 120, AVs 110, or client devices 130. The third-party system 160 may be a provider of one or more virtual environments. For instance, the third-party system 160 provide a network of virtual worlds, such as a metaverse. The virtual environment facilitates virtual activities of users, such as interactions (e.g., communications, transactions, etc.) between users, entertainment activities (e.g., games, sporting events, interactive experiences, etc.), work activities, or other types of virtual activities. The virtual environment may simulate a real-world environment. Alternatively, the virtual environment may be generated by augmenting a real-world environment, e.g., by including virtual objects simulating real-world objects and other virtual objects. A portion or the whole virtual environment may be generated by the third-party system 160, a user of the third-party system 160, or a different system associated with the third-party system 160. The third-party system 160 may provide the virtual environment (or access to the virtual environment) to the fleet management system 120, an AV 110, or a client device 130. In an example, the fleet management system 120, AV 110, or client device 130 may subscribe an access to the virtual environment. Also, the fleet management system 120, AV 110, or client device 130 may modify the virtual environment, e.g., add new virtual objects into the virtual environment, edit a virtual object in the virtual environment, remove a virtual object in the virtual environment, and so on.

### Example Sensor Suite

FIG. 2 is a block diagram showing the sensor suite 140, according to some embodiments of the present disclosure. The sensor suite 140 includes an exterior sensor 210, a LIDAR sensor 220, a RADAR sensor 230, and an interior sensor 240. The sensor suite 140 may include any number of the types of sensors shown in FIG. 2, e.g., one or more exterior sensor 210, one or more LIDAR sensors 220, etc. The sensor suite 140 may have more types of sensors than those shown in FIG. 2, such as the sensors described with respect to FIG. 1. In other embodiments, the sensor suite 140 may not include one or more of the sensors shown in FIG. 2.

The exterior sensor 210 detects objects in an environment around the AV 110. The environment may include a scene in which the AV 110 operates. Example objects include persons, buildings, traffic lights, traffic signs, vehicles, street signs, trees, plants, animals, or other types of objects that may be present in the environment around the AV 110. In some embodiments, the exterior sensor 210 includes exterior cameras having different views, e.g., a front-facing camera, a back-facing camera, and side-facing cameras. One or more exterior sensor 210 may be implemented using a high-resolution imager with a fixed mounting and field of view. One or more exterior sensors 210 may have adjustable field of views and/or adjustable zooms. In some embodiments, the exterior sensor 210 may operate continually during operation of the AV 110. In an example embodiment, the exterior sensor 210 captures sensor data (e.g., images, etc.) of a scene in which the AV 110 drives.

The LIDAR sensor 220 measures distances to objects in the vicinity of the AV 110 using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV 110.

The RADAR sensor 230 can measure ranges and speeds of objects in the vicinity of the AV 110 using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

The interior sensor 240 detects the interior of the AV 110, such as objects inside the AV 110. Example objects inside the AV 110 include passengers, client devices of passengers, components of the AV 110, items delivered by the AV 110, items facilitating services provided by the AV 110, and so on. The interior sensor 240 may include multiple interior cameras to capture different views, e.g., to capture views of an interior feature, or portions of an interior feature. The interior sensor 240 may be implemented with a fixed mounting and fixed field of view, or the interior sensor 240 may have adjustable field of views and/or adjustable zooms, e.g., to focus on one or more interior features of the AV 110. The interior sensor 240 may operate continually during operation of the AV 110. The interior sensor 240 may also include one or more microphones that can capture sound in the AV 110, such as a conversation made by a passenger. The interior sensor 240 may transmit sensor data to a perception module (such as the perception module 430 described below in conjunction with FIG. 5), which can use the sensor data to classify a feature and/or to determine a status of a feature. The interior sensor 240 may also include one or more motion sensors that can detect movement inside or outside of the AV 110, or one or more air analysis sensors that can detect chemicals in the air.

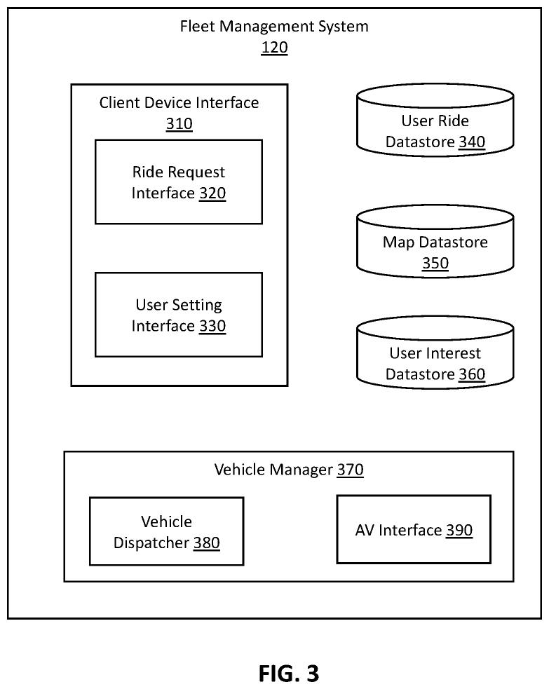

FIG. 3 is a block diagram showing the fleet management system according to some embodiments of the present disclosure. The fleet management system 120 includes a client device interface 310, various data stores 340-460, and a vehicle manager 370. The client device interface 310 includes a ride request interface 320 and user setting interface 330. The data stores include user ride datastore 340, map datastore 350, and user interest datastore 360. The vehicle manager 370 includes a vehicle dispatcher 380 and an AV interface 390. In alternative configurations, different and/or additional components may be included in the fleet management system 120. Further, functionality attributed to one component of the fleet management system 120 may be accomplished by a different component included in the fleet management system 120 or a different system than those illustrated.

The client device interface 310 provides interfaces to client devices, such as headsets, smartphones, tablets, computers, and so on. For example, the client device interface 310 may provide one or more apps or browser-based interfaces that can be accessed by users, such as the users 135, using client devices, such as the client devices 130. The client device interface 310 includes the ride request interface 320, which enables the users to submit requests to a ride service provided or enabled by the fleet management system 120. In particular, the ride request interface 320 enables a user to submit a ride request that includes an origin (or pickup) location and a destination (or drop-off) location. The ride request may include additional information, such as a number of passengers traveling with the user, and whether or not the user is interested in shared ride with one or more other passengers not known to the user.

The client device interface 310 further includes a user setting interface 330 in which a user can select ride settings. The user setting interface 330 can provide one or more options for the user to engage in a virtual environment, such as whether to interact with another person, whether to involve in an entertainment activity, and so on. The user setting interface 330 may enable a user to opt-in to some, all, or none of the virtual activities offered by the ride service provider. The user setting interface 330 may further enable the user to opt-in to certain monitoring features, e.g., to opt-in to have the interior sensor 240 obtain sensor data of the user. The user setting interface 330 may explain how this data is used by the virtual environment platform (e.g., for eye or gaze tracking, to assess the flow of a conversation, to assess boredom, to hear spoken responses to game prompts, etc.) and may enable users to selectively opt-in to certain monitoring features, or to opt-out of all of the monitoring features. In some embodiments, the virtual environment platform may provide a modified version of a virtual activity if a user has opted out of some or all of the monitoring features.

The user ride datastore 340 stores ride information associated with users of the ride service, e.g., the users 135. The user ride datastore 340 may store an origin location and a destination location for a user's current ride. The user ride datastore 340 may also store historical ride data for a user, including origin and destination locations, dates, and times of previous rides taken by a user. In some cases, the user ride datastore 340 may further store future ride data, e.g., origin and destination locations, dates, and times of planned rides that a user has scheduled with the ride service provided by the AVs 110 and fleet management system 120.

The map datastore 350 stores a detailed map of environments through which the AVs 110 may travel. The map datastore 350 includes data describing roadways, such as e.g., locations of roadways, connections between roadways, roadway names, speed limits, traffic flow regulations, toll information, etc. The map datastore 350 may further include data describing buildings (e.g., locations of buildings, building geometry, building types), and data describing other objects (e.g., location, geometry, object type) that may be in the environments of AV 110. The map datastore 350 may also include data describing other features, such as bike lanes, sidewalks, crosswalks, traffic lights, parking lots, signs, billboards, etc.

Some of the map datastore 350 may be gathered by the fleet of AVs 110. For example, images obtained by the exterior sensor 210 of the AVs 110 may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 350. In some embodiments, certain feature data (e.g., seasonal data, such as Christmas decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map datastore 350.

The user interest datastore 360 stores data indicating user interests associated with rides in AVs. The fleet management system 120 may include one or more learning modules (not shown in FIG. 3) to learn user interests based on user data. For example, a learning module may compare locations in the user ride datastore 340 with map datastore 350 to identify places the user has visited or plans to visit. For example, the learning module may compare an origin or destination address for a user in the user ride datastore 340 to an entry in the map datastore 350 that describes a building at that address. The map datastore 350 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user interest datastore 360.

The user interest datastore 360 also stores data indicating user interests for engaging in virtual environments, such as interests in virtual interaction, interests in virtual games, etc. The user interest datastore 360 may store data associated with a user's historical virtual activities, such as historical virtual interactions of the user with other users, historical digital interactive experiences of the user, and so on. The user interest datastore 360 may also store information associated with client devices that users use to access virtual environments. Additionally or alternatively, the user interest datastore 360 stores information received through the user setting interface 330. The learning module or another learning module may determine user interests associated with virtual environments. For example, the learning module may use data associated with a user's historical virtual activities to determine the user's interest in future virtual activities. The user interest datastore 360 may store interests from other sources, e.g., interests acquired from third-party data providers that obtain user data; interests expressly indicated by the user (e.g., in the user settings interface 330); other ride data (e.g., different cities or countries in which the user has used the ride service may indicate interest in these geographic areas); stored gaze detection data (e.g., particular features in environment outside AVs that the user has looked at); etc.

The vehicle manager 370 manages and communicates with the fleet of AVs 110. The vehicle manager 370 assigns the AVs 110 to various tasks and directs the movements of the AVs 110 in the fleet. The vehicle manager 370 includes a vehicle dispatcher 380 and an AV interface 390. In some embodiments, the vehicle manager 370 includes additional functionalities not specifically shown in FIG. 3. For example, the vehicle manager 370 instructs AVs 110 to drive to other locations while not servicing a user, e.g., to improve geographic distribution of the fleet, to anticipate demand at particular locations, etc. The vehicle manager 370 may also instruct AVs 110 to return to an AV facility for fueling, inspection, maintenance, or storage.

The vehicle dispatcher 380 selects AVs from the fleet to perform various tasks and instructs the Avs 110 to perform the tasks. For example, the vehicle dispatcher 380 receives a ride request from the ride request interface 320. The vehicle dispatcher 380 selects an AV 110 to service the ride request based on the information provided in the ride request, e.g., the origin and destination locations. In some embodiments, the vehicle dispatcher 380 selects an AV 110 based on a user's interest in virtual interaction. For example, if the ride request indicates that a user is interested in interaction with other uses through virtual scenes, the vehicle dispatcher 380 may dispatch an AV 110 traveling along or near the route requested by the ride request that has a second passenger interested in virtual interaction. Conversely, if the ride request indicates that a user is open to a shared ride but is not interested in virtual interaction, the vehicle dispatcher 380 may dispatch an AV 110 traveling along or near the route requested by the ride request with a second passenger that is also not interested in virtual interaction.

If multiple AVs 110 in the AV fleet are suitable for servicing the ride request, the vehicle dispatcher 380 may match users for shared rides based on an expected compatibility for virtual activities. For example, if multiple virtual activities (e.g., virtual interaction, game, etc.) are available, the vehicle dispatcher 380 may match users with an interest in the same type of virtual activity for a ride in an AV 110. As another example, the vehicle dispatcher 380 may match users with similar user interests, e.g., as indicated by the user interest datastore 360. This may improve a quality of virtual interaction or other virtual activity, as the virtual activity may focus on an interest in common to multiple users. In some embodiments, the vehicle dispatcher 380 may match users for shared rides based on previously-observed compatibility or incompatibility when the users had previously shared a ride.

The vehicle dispatcher 380 or another system may maintain or access data describing each of the AVs in the fleet of AVs 110, including current location, service status (e.g., whether the AV is available or performing a service; when the AV is expected to become available; whether the AV is schedule for future service), fuel or battery level, etc. The vehicle dispatcher 380 may select AVs for service in a manner that optimizes one or more additional factors, including fleet distribution, fleet utilization, and energy consumption. The vehicle dispatcher 380 may interface with one or more predictive algorithms that project future service requests and/or vehicle use, and select vehicles for services based on the projections.

The vehicle dispatcher 380 transmits instructions dispatching the selected AVs. In particular, the vehicle dispatcher 380 instructs a selected AV to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle dispatcher 380 may dispatch the same AV 110 to pick up additional users at their pickup locations, e.g., the AV 110 may simultaneously provide rides to three, four, or more users. The vehicle dispatcher 380 further instructs the AV 110 to drive autonomously to the respective destination locations of the users.

The AV interface 390 interfaces with the AVs 110, and in particular, with the onboard computer 150 of the AVs 110. The AV interface 390 may receive sensor data from the AVs 110, such as camera images, captured sound, and other outputs from the sensor suite 140. The AV interface 390 may further interface with a system that facilitates virtual environments, e.g., the virtual environment manager 450. For example, the AV interface 390 may provide user ride datastore 340 and/or user interest datastore 360 to the virtual environment manager 450, which may use this data to generate a virtual scene for a user. The AV interface 390 may also provide user settings, e.g., data regarding virtual activity preferences, received through the user setting interface 330 to the virtual environment manager 450. The AV interface 390 may also provide a virtual environment from a third-party system, or provide access to the third-party's virtual environment.

### Example Onboard Computer

FIG. 4 is a block diagram showing the onboard computer 150_{[BD1]} of the AV according to some embodiments of the present disclosure. The onboard computer 150 includes map data 410, a sensor interface 420, a perception module 430, a control module 440, and a virtual environment manager 450. In alternative configurations, fewer, different and/or additional components may be included in the onboard computer 150. For example, components and modules for conducting route planning, controlling movements of the AV 110, and other vehicle functions are not shown in FIG. 4. Further, functionality attributed to one component of the onboard computer 150 may be accomplished by a different component included in the onboard computer 150 or a different system, such as the fleet management system 120.

The map data 410 stores a detailed map that includes a current environment of the AV 110. The map data 410 may include any of the map datastore 350 described in relation to FIG. 4. In some embodiments, the map data 410 stores a subset of the map datastore 350, e.g., map data for a city or region in which the AV 110 is located.

The sensor interface 420 interfaces with the sensors in the sensor suite 140. The sensor interface 420 may request data from the sensor suite 140, e.g., by requesting that a sensor capture data in a particular direction or at a particular time. For example, in response to the perception module 430 or another module determining that a user is in a particular seat in the AV 110 (e.g., based on images from an interior sensor 240, a weight sensor, or other sensors), the sensor interface 420 instructs the interior sensor 240 to capture sensor data of the user. As another example, in response to the perception module 430 or another module determining that the one or more users have entered the passenger compartment, the sensor interface 420 instructs the interior sensor 240 to capture sound. The sensor interface 420 is configured to receive data captured by sensors of the sensor suite 140, including data from exterior sensors mounted to the outside of the AV 110, and data from interior sensors mounted in the passenger compartment of the AV 110. The sensor interface 420 may have subcomponents for interfacing with individual sensors or groups of sensors of the sensor suite 140, such as a camera interface, a LIDAR interface, a RADAR interface, a microphone interface, etc.

The perception module 430 identifies objects and/or other features captured by the sensors of the AV 110. For example, the perception module 430 identifies objects in the environment of the AV 110 and captured by one or more exterior sensors (e.g., the sensors 210-230). The perception module 430 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc. The perception module 430 may identify travel speeds of identified objects based on data from the RADAR sensor 230, e.g., speeds at which other vehicles, pedestrians, or birds are traveling. As another example, the perception module 43—may identify distances to identified objects based on data (e.g., a captured point cloud) from the LIDAR sensor 220, e.g., a distance to a particular vehicle, building, or other feature identified by the perception module 430. The perception module 430 may also identify other features or characteristics of objects in the environment of the AV 110 based on image data or other sensor data, e.g., colors (e.g., the colors of Christmas lights), sizes (e.g., heights of people or buildings in the environment), makes and models of vehicles, pictures and/or words on billboards, etc.

The perception module 430 may further process data from captured by interior sensors (e.g., the interior sensor 240 of FIG. 2) to determine information about and/or behaviors of passengers in the AV 110. For example, the perception module 430 may perform facial recognition based on sensor data from the interior sensor 240 to determine which user is seated in which position in the AV 110. As another example, the perception module 430 may process the sensor data to determine passengers' states, such as gestures, activities (e.g., whether passengers are engaged in conversation), moods (whether passengers are bored (e.g., having a blank stare, or looking at their phones)), and so on. The perception module may analyze data from the interior sensor 240, e.g., to determine whether passengers are talking, what passengers are talking about, the mood of the conversation (e.g., cheerful, annoyed, etc.). In some embodiments, the perception module 430 may determine individualized moods, attitudes, or behaviors for the users, e.g., if one user is dominating the conversation while another user is relatively quiet or bored; if one user is cheerful while the other user is getting annoyed; etc. In some embodiments, the perception module 430 may perform voice recognition, e.g., to determine a response to a game prompt spoken by a user.

In some embodiments, the perception module 430 fuses data from one or more interior sensor 240 with data from exterior sensors (e.g., exterior sensor 210) and/or map data 410 to identify environmental objects that one or more users are looking at. The perception module 430 determines, based on an image of a user, a direction in which the user is looking, e.g., a vector extending from the user and out of the AV 110 in a particular direction. The perception module 430 compares this vector to data describing features in the environment of the AV 110, including the features' relative location to the AV 110 (e.g., based on real-time data from exterior sensors and/or the AV's real-time location) to identify a feature in the environment that the user is looking at.

While a single perception module 430 is shown in FIG. 4, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 440 controls operations of the AV 110, e.g., based on information from the sensor interface 420 or the perception module 430. In some embodiments, the control module 440 controls operation of the AV 110 by using a trained model, such as a trained neural network. The control module 440 may provide input data to the control model, and the control model outputs operation parameters for the AV 110. The input data may include sensor data from the sensor interface 420 (which may indicate a current state of the AV 110), objects identified by the perception module 430, or both. The operation parameters are parameters indicating operation to be performed by the AV 110. The operation of the AV 110 may include perception, prediction, planning, localization, motion, navigation, other types of operation, or some combination thereof. The control module 440 may provide instructions to various components of the AV 110 based on the output of the control model, and these components of the AV 110 will operation in accordance with the instructions. In an example where the output of the control model indicates that a change of traveling speed of the AV 110 is required given a prediction of traffic condition, the control module 440 may instruct the motor of the AV 110 to change the traveling speed of the AV 110. In another example where the output of the control model indicates a need to detect characteristics of an object in the environment around the AV 110 (e.g., detect a speed limit), the control module 440 may instruct the sensor suite 140 to capture an image of the speed limit sign with sufficient resolution to read the speed limit and instruct the perception module 430 to identify the speed limit in the image.

The virtual environment manager 450 provides virtual scenes to client devices, e.g., based on data from one or more other components of the onboard computer 150. The client devices can display the virtual scenes to passengers. In some embodiments, a client device may display a virtual scene as a VR scene. In other embodiments, the client device may use a virtual scene to augment a real-world scene and display an AR scene (which may include both the virtual scene and the real-world scene) or MR scene. The virtual environment manager 450 can detect a client device, e.g., based on sensor data from an interior sensor of the AV 110, a passenger's identification of the client device (e.g., a request to send a virtual scene to the client device), information from the fleet management system 120, a connection to the client device through a network, and so on. In some embodiments, the virtual environment manager 450 may query the client device whether the client device would like to receive a virtual scene, and in response to a yes from the client device (e.g., a yes from the passenger provided through an interface on the client device), generate and send the virtual scene to the client device.

The virtual environment manager 450 may generate a virtual scene including one or more virtual objects. A virtual object may be a virtual representation of a real-world object. The real-world object may be in a real-world environment surrounding the AV 110 and may be detected by the sensor suite of the AV 110. Examples of the real-world object may include the passenger, another person (e.g., another passenger in the AV 110, a passenger in another AV, a person seeking a ride in an AV, or other persons), the AV 110, another AV (e.g., another AV driving in the surroundings of the AV), other objects in the real-world environment surrounding the AV (e.g., buildings, streets, traffic signs, trees, etc.). A virtual representation may be an avatar, a two-dimensional (2D) model (e.g., a 2D image), a three-dimensional (3D) model (e.g., a 3D image), and so on. In some embodiments, the virtual representation can be dynamic or animated. For instance, the virtual representation of a person may make gestures or other activities that simulate such activities of the person. Also, the virtual representation of an AV may drive in the virtual scene. The virtual scene may include a video of a real-world object.

The virtual representation of a real-world object (e.g., AV, person, building, street signs, etc.) may have one or more features of the real-world object and may have additional features that augment the real-world object. For instance, the virtual representation of a real-world object may have a different attribute from the real-world object. For instance, a virtual representation of the passenger may be “enlarged,” e.g., to make the face of the virtual representation visible in the virtual scene. In an example, a ratio of a size of a first virtual object to a size of a second virtual object is different from a ratio between the sizes of the real-world objects represented by the two virtual objects.

The virtual environment manager 450 can also generate other virtual objects, such as augmentation objects. In some embodiments, an augmentation object is a virtual object that augments a real real-world environment. The augmentation object may be an object that is absent in the real-world environment. For example, the augmentation object may fall in a class of objects that is under-represented or absent in the in the real-world environment. The virtual environment manager 450 may also generate a virtual scene that does not simulate the real-world environment of the AV. In some embodiments, the virtual environment manager 450 generates the virtual scene based on a virtual environment, such as a metaverse. The virtual environment (or access to the virtual environment) may be provided by the fleet management system 120 or third-party system 160. The virtual environment manager 450 may modify the virtual environment to generate the virtual scene, e.g., by adding in a virtual representation of the passenger or a virtual representation of the AV 110, or other virtual objects. The virtual environment manager 450 may modify the virtual environment by adding the virtual scene to the virtual environment, and the virtual scene can become a part of the virtual environment. For instance, the virtual environment manager 450 generates a virtual scene that simulates the AV 110 and one or more passengers in the AV 110, and can place the virtual scene into a virtual environment that includes other simulated AVs and avatars of other people.

The virtual environment manager 450 may generate one or more virtual objects based on the ride in the AV, such as operational behaviors of the AV. For instance, the virtual environment manager 450 may generate virtual objects (e.g., blocks) on a navigation route of the AV in the virtual scene based on deacceleration or turning of the AV. The virtual environment manager 450 may also generate one or more virtual objects based on a state of the passenger, such as a gesture, communication, and so on. For instance, the virtual environment manager 450 may generate one or more messages (e.g., text message, audio message, video message, etc.) based on a communication of the passenger in the AV 110, which may be detected by an interior sensor of the AV 110. The messages may include the content of the communication, the mood of the passenger in the communication, or other information associated with the communication.

The virtual environment manager 450 enables passengers to perform activities in virtual environments. The passenger can play a virtual game in the virtual environment. The virtual environment includes a scene for the game. The passenger may engage with virtual objects in the game scene to get entertained. Additionally or alternatively, the passenger can interact with other people through the virtual environment. For instance, the passenger and another person can access the same virtual environment, which includes virtual representations of both. The avatar of the passenger can interact with the avatar of the person in the same virtual environment. They can talk to each other, send messages to each other, play a game together, work together, and so on. In some embodiments, the interaction may represent a real-world interaction. For instance, the virtual environment manager 450 detects an interaction between the passenger and another person, e.g., based on sensor data. The virtual environment manager 450 projects the interaction into the virtual environment. The virtual environment manager 450 may generate one or more messages based on the detected interaction and include the messages in the virtual environment. The passenger and person may continue their interaction through the virtual environment.

The virtual environment manager 450 may control or modify the AV ride (e.g., behaviors of the AV 110) based on engagement of the passenger with the virtual scene. The virtual environment manager 450 may provide instructions to the control module 440 and the control module 440 changes behaviors of the AV in accordance with the instructions. In some embodiments, the virtual environment manager 450 may control or modify the AV ride based on an interaction of the passenger with another person in the virtual scene. In an embodiment, the virtual environment manager 450 may change a navigation route of the AV 110 based on a location indicated in the interaction. For instance, the passenger and the person may agree to meet at a location (e.g., a location for a meet-up, a location to pick up the person, a location to drop off the passenger, etc.) in the virtual scene. The virtual environment manager 450 can identify the location and add the location as a destination of the AV 110. The virtual environment manager 450 may send a query to the client device to request the passenger's permission for changing the navigation route, and change the navigation route after the passenger's permission is received. In another embodiment, the virtual environment manager 450 may change a setting of a component of the AV based on an interaction in the virtual scene. For instance, after detecting that the avatar of the passenger says hello to the avatar of a person sitting in another AV 110, the virtual environment manager 450 can turn the headline of the AV on and off to get the person's attention in the real-world environment.

In other embodiments, the virtual environment manager 450 may control or modify the AV ride based on a game that the passenger plays through the virtual scene. For instance, the virtual environment manager 450 may determine a motion of the AV 110 that can augment the passenger's excitement in the game. The virtual environment manager 450 may predict an activity of a virtual representation of the passenger in the game and determine or modify a motion of the AV 110 based on the prediction. The virtual environment manager 450 may select a navigation route that includes a road condition that can trigger the motion of the AV 110. In an example where an avatar of the passenger will fall in the game, the virtual environment manager 450 may predict the fall of the avatar and select a navigation route that includes a downward slope so that the passenger will feel the loss of gravity.

In some embodiments, the virtual environment manager 450 may change lighting color inside or outside of the AV 110 based on the virtual environment, e.g., based on a change in the virtual environment, a virtual activity of the passenger in the virtual environment, and so on. As an example, if the passenger wins a game in the virtual environment, the virtual environment manager 450 may set the color of a light in the real-world to green, whereas if the passenger loses the game, the virtual environment manager 450 may set the color of the light in the real-world to red. As another example, the virtual environment manager 450 may modify the brightness of a real-world light based on a change in the lighting brightness in the virtual environment, which may enhance the passenger's sense of immersion in the virtual environment. The virtual environment manager 450 may also control or modify one or more real-world objects that are outside of the AV 110 based on the virtual environment. In an example, the virtual environment manager 450 may change a road condition (e.g., blocking a road, etc.) given that one or more conditions are not met in the virtual environment. A condition in the virtual environment may be a target virtual activity to be performed by the passenger. The virtual environment manager 450 may detect the passenger's failure to perform the target virtual activity and change the road condition based on the detection. In another example, the virtual environment manager 450 may modify a behavior of another AV based on the virtual environment. The virtual environment manager 450 may modify the behavior of the other AV by sending a request for modifying the behavior to an onboard computer of the other AV.

### Example Virtual Scene Projected to Client Device

FIG. 5A illustrates a real-world environment 500 in which a user 535 has a ride in an AV 510, according to some embodiments of the present disclosure. The user 535 is a passenger in the AV 510 and sits on a seat 515 in the AV 510. The user 535 is wearing a headset 530, which can display VR, AR, or MR scenes to the user 535. The headset 530 may be an embodiment of a client device 130. The real-world environment 500 also includes streets 520 and 525, a stop sign 540, a person 550, a tree 560, a building 570, a street sign 580, and another AV 590. The AVs 510 and 590 drive in the real-world environment 500. The AV 510 or 590 may be an embodiment of the AV 110. The AVs 510 and 590 may be in a same fleet of AVs and managed by the fleet management system 120. Even though not shown in FIG. 5A, the AV 690 may also have a passenger.

FIG. 5B illustrates a virtual scene 501 projected to the user 535 in the AV 510, according to some embodiments of the present disclosure. The virtual scene 501 may be provided by an onboard computer of the AV 510, e.g., the onboard computer 150, to the headset 530, which displays the virtual scene 501 to the user 535.

The virtual scene 501 shows a communication between the user 535 and another person. The user 535 is represented by an avatar 502, and the other person is represented by an avatar 503. The other person may be a passenger in the AV 590, a passenger in another AV which may or may not in the real-world environment 500, or a person that is not in any AV. The communication includes two messages 504A and 504B. For purpose of simplicity and illustration, the communication is shown in the virtual scene 501 as text. In other embodiments, the communication can be in different formats, such as an audio (e.g., an audio call), a video (e.g., a video call), or some combination thereof. The communication indicates a location, i.e., the location of Store A. The onboard computer of the AV 510 may detect the location from the communication and modify navigation of the AV 510 based on the location. For instance, the onboard computer may change the destination of the ride to the location of Store A, or add the location of Store A as a new stop. The onboard computer of the AV 510 may also control one or more components of the AV 510 to facilitate a communication. For example, the AV 510 may drive towards the AV 590 so that the user 535 can see a passenger of the AV 590 in the real-world. As another example, a headlight can be turned on and off or the horn can be activated to get the attention of a passenger in the AV 590. As yet another example, a music or video (e.g., a movie) can be played through the onboard computer or the headset 530 based on a communication, e.g., a communication discussing the music or video.

The virtual scene 501 also shows a game that the user 535 is playing during the ride. For purpose of illustration, the game is a racing game that includes a racing car 505, other cars 506 (individually referred to as “car 506”), a driver 507 in the racing car 505, and a flag set 508 that indicates an end of the racing. The racing car 505 may be a virtual representation of the AV 510. The driver 507 may be a virtual representation of the user 535. In some embodiments, the game scene is generated based on the ride in the real-world environment 500. For instance, the flag set 508, which can trigger the racing car 505 to stop in the game, may be generated based on the presence of the stop sign 540, which triggers the AV 510 to stop in the real-world. Also, behaviors of the AV 510 may be modified based on the game, such as activities of the driver 507 in the game. The AV 510 may accelerate or deaccelerate in the real-world as the driver 507 accelerates or deaccelerates the racing car 505 in the game, so that the user 535 feels the acceleration or deceleration, which can augment the entertainment the user 535 can get from the game. Also, the seat 515 can be moved, e.g., based on instructions from the onboard computer, to simulate a movement of the driver 507 in the game.

### Example Method of Projecting Virtual Scene to Client Device

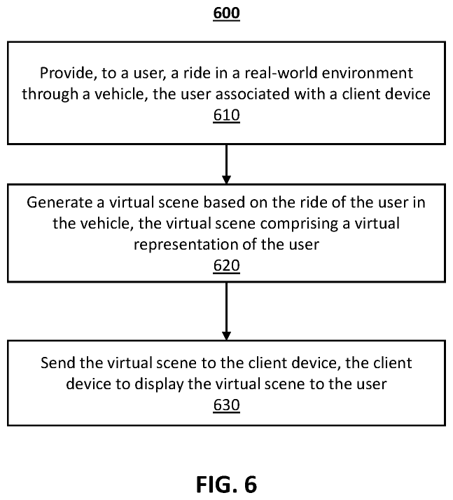

FIG. 6 is a flowchart showing a method 600 of projecting a virtual scene to an AV passenger, according to some embodiments of the present disclosure. The method 600 may be performed by the virtual environment manager 450. Although the method 600 is described with reference to the flowchart illustrated in FIG. 6, many other methods of projecting a virtual scene to an AV passenger may alternatively be used. For example, the order of execution of the steps in FIG. 6 may be changed. As another example, some of the steps may be changed, eliminated, or combined.

The virtual environment manager 450 provides, in 610, to a user, a ride in a real-world environment through a vehicle. The user is associated with a client device. The vehicle may be an AV, such as an AV 110, that operates in a real-world environment. For instance, the AV drives in the real-world environment from a pickup location to a drop-off location of the user. The virtual environment manager 450 may detect the client device, e.g., based on a connection with the client device through a network, an identification of the client device by the user, or sensor data capturing the client device in the AV. In some embodiments, the virtual environment manager 450 detects the client device based on information provided by the fleet management system 120.

The virtual environment manager 450 generates, in 620, a virtual scene based on the ride of the user in the vehicle. The virtual scene may be a virtual world or a part of a virtual world where the user can perform virtual activities. The virtual scene includes a virtual representation of the user or the vehicle. The virtual representation of the user may include a first feature that the user has and a second feature that the user does not have. The virtual environment manager 450 may detect an activity of the user in the real-world (e.g., inside the vehicle during the ride) and generate an animation illustrating the activity of the user. The virtual scene includes the animation. The activity may be a gesture, a facial expression, a sound, and so on. The user's activity in the real-world may be captured by a sensor in the AV. The virtual environment manager 450 can transform the user's activity in the real-world to a virtual activity in the virtual scene. For example, the user may wave his or her hand in the real-world, which may be captured by a camera in the AV, and the virtual environment manager 450 can generate an animation of the user's avatar (or other types of virtual representation of the user) waving hand in the virtual scene. As another example, the user says words in the real-world, which may be captured by a microphone in the AV, and the virtual environment manager 450 can generate an audio and include the audio in the virtual scene, e.g., as a voice of the user's avatar. The virtual environment manager 450 can also generate an animation of the user's avatar in which the mouth or throat of the avatar moves as the audio is played to imitate the user talking.

The virtual environment manager 450 may also generate a virtual representation of a real-world object in the real-world environment. The virtual scene includes the virtual representation of the real-world object. The real-world object may be detected by one or more sensors of the AV, and the virtual environment manager 450 can generate the virtual representation based on the sensor data. The virtual environment manager 450 may also generate generating an augmentation object. The augmentation object represents a class of objects that is absent in the real-world environment, and the virtual scene includes the augmentation object.

In some embodiments, the virtual environment manager 450 accesses a virtual environment (e.g., a metaverse) and generates the virtual scene by modifying the virtual environment to include the virtual representation. The virtual environment manager 450 may receive the virtual environment from the fleet management system 120 or a third-party system. For example, the fleet management system 120 may get access to the virtual environment from the third-party system (e.g., through a subscription) and provide the access to the virtual environment manager 450. In other embodiments, the virtual environment manager 450 may access a network of one or more other virtual scenes and connect the virtual scene with the other virtual scenes through the network. The user may be able to engage with the other virtual scenes, in addition to the virtual scene generated by the virtual environment manager 450, through the network.

The virtual environment manager 450 may identify an object in the virtual environment and modify one or more operational behaviors of the AV based on the object. For example, the virtual environment manager 450 may identify a virtual representation of another AV, which provides a ride to another person, and may turn on and off a headlight to get the attention of the other AV or the other person. The virtual environment manager 450 may generate a virtual object based on one or more operational behaviors of the AV.

In some embodiments, the virtual environment manager 450 generates a first virtual representation of the user and generates a second virtual representation of the AV. The virtual scene includes the first virtual representation and the second virtual representation. A ratio of a size of the first virtual representation to a size of the second virtual representation may be different from a ratio of a size of the user to a size of the AV. The first virtual representation may be relatively larger so that it can be more visible in the virtual scene. The first virtual representation may be an avatar of the user.

The virtual environment manager 450 sends, in 630, the virtual scene to the client device. The client device will display the virtual scene to the user. The client device can facilitate the user to perceive and engage in the virtual scene, or a virtual world of which the virtual scene is a part. The user, through his or her virtual representation, can perceive his or her existing in the virtual scene. The user can also make changes to the virtual scene, which may be perceived by other users, such as through their client devices.

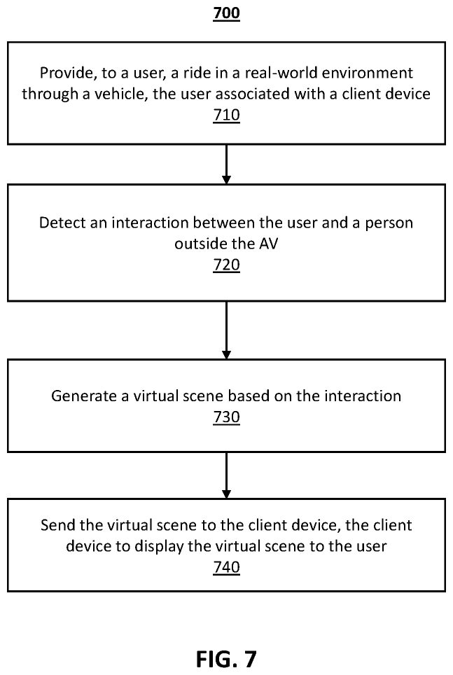

FIG. 7 is a flowchart showing another method 700 of projecting a virtual scene to an AV passenger, according to some embodiments of the present disclosure. The method 700 may be performed by the virtual environment manager 450. Although the method 700 is described with reference to the flowchart illustrated in FIG. 7, many other methods of projecting a virtual scene to an AV passenger may alternatively be used. For example, the order of execution of the steps in FIG. 7 may be changed. As another example, some of the steps may be changed, eliminated, or combined.

The virtual environment manager 450 provides, in 610, to a user, a ride in a real-world environment through a vehicle. The user is associated with a client device. The vehicle may be an AV, such as an AV 110, that operates in a real-world environment. For instance, the AV drives in the real-world environment from a pickup location to a drop-off location of the user. The virtual environment manager 450 may detect the client device, e.g., based on a connection with the client device through a network, an identification of the client device by the user, or sensor data capturing the client device in the AV. In some embodiments, the virtual environment manager 450 detects the client device based on information provided by the fleet management system 120.

The virtual environment manager 450 detects, in 720, an interaction between the user and a person outside the AV. In some embodiments, the interaction is conducted in a virtual environment, e.g., a virtual environment that the user can engage with through the client device or a different device. In other embodiments, the interaction is conducted in the real-world environment. The interaction may be an interaction inside the AV (e.g., an interaction between passengers of the AV), an interaction through the client device or another device (e.g., a phone call, a video call, text messages, etc.). The virtual environment manager 450 may detect the interaction based on one or more sensors inside the AV, e.g., the interior sensor 240.

The virtual environment manager 450 generates, in 730, a virtual scene based on the interaction. The virtual scene includes a virtual representation of the user, the person, or the AV. The virtual representation of the user may include a first feature that the user has and a second feature that the user does not have. The virtual environment manager 450 may detect a gesture of the user in the AV. The gesture may be part of the interaction. The virtual environment manager 450 may generate an animation illustrating the gesture and include the animation in the virtual scene. The virtual scene may include a virtual representation of a real-world object in the real-world environment. The real-world object may be an additional AV operating in the real-world environment, and the person has a ride in the additional AV. For instance, the user and another person may interact in the virtual scene through their virtual representations.

The virtual environment manager 450 may also generate an augmentation object. The augmentation object represents a class of objects that is absent in the real-world environment, and the virtual scene includes the augmentation object. The interaction may include a conversation between the user and the person. The virtual environment manager 450 may generate the augmentation object based on information in the conversation. For instance, the virtual environment manager 450 may generate audio (e.g., music) or video (e.g., movie) based on a discussion of the audio or video in the conversation. In some embodiments, the virtual environment manager 450 identifies a location based on the interaction and modifies a navigation route of the AV based on the location. In other embodiments, the virtual environment manager 450 can modify a setting of a component of the AV based on the interaction.

The virtual environment manager 450 sends, in 630, the virtual scene to the client device. The client device will display the virtual scene to the user. The client device can facilitate the user to perceive and engage in the virtual scene, or a virtual world of which the virtual scene is a part. The user, through his or her virtual representation, can perceive his or her existing in the virtual scene. The user can also make changes to the virtual scene, which may be perceived by other users, such as through their client devices. In some embodiments, the virtual environment manager 450 may modify one or more operational behaviors of the vehicle based on the virtual scene. Additionally or alternatively, the virtual environment manager 450 may control one or more real-world objects outside the vehicle based on the virtual scene.

### SELECT EXAMPLES

Example 1 provides a method, including providing, to a user, a ride in a real-world environment through a vehicle, the user associated with a client device; generating a virtual scene based on the ride of the user in the vehicle, the virtual scene including a virtual representation of the user or the vehicle; and sending the virtual scene to the client device, the client device configured to display the virtual scene to the user.

Example 2 provides the method of example 1, where generating the virtual scene includes accessing a virtual environment; and generating the virtual scene by modifying the virtual environment to include the virtual representation.

Example 3 provides the method of example 1, further including modifying one or more operational behaviors of the vehicle in the real-world environment based on the virtual scene, where modifying the one or more operational behaviors of the vehicle in the real-world environment based on the virtual scene may include changing a navigation route of the vehicle in the real-world environment based on an engagement of the user with the virtual scene.

Example 4 provides the method of example 1, further including modifying a real-world object outside the vehicle based on the virtual scene.

Example 5 provides the method of example 1, where generating the virtual scene includes generating a first virtual representation of the user; and generating a second virtual representation of the vehicle, where the virtual scene includes the first virtual representation and the second virtual representation, and a ratio of a size of the first virtual representation to a size of the second virtual representation is different from a ratio of a size of the user to a size of the vehicle.

Example 6 provides the method of example 1, where the virtual representation of the user includes a feature of the user and a feature absent from the user.

Example 7 provides the method of example 1, where generating the virtual scene includes detecting an activity of the user in the vehicle; generating an animation illustrating the activity of the user, where the virtual scene includes the animation.

Example 8 provides the method of example 1, where generating the virtual scene includes generating a virtual representation of a real-world object in the real-world environment, the virtual scene including the virtual representation.

Example 9 provides the method of example 1, where generating the virtual scene includes generating an augmentation object, where the augmentation object represents a class of objects that is absent in the real-world environment, and the virtual scene includes the augmentation object.

Example 10 provides the method of example 1, where generating a virtual scene includes generating a virtual object based on one or more operational behaviors of the vehicle.

Example 11 provides one or more non-transitory computer-readable media storing instructions executable to perform operations, the operations including: providing, to a user, a ride in a real-world environment through a vehicle, the user associated with a client device; generating a virtual scene based on the ride of the user in the vehicle, the virtual scene including a virtual representation of the user or the vehicle; and sending the virtual scene to the client device, the client device configured to display the virtual scene to the user.

Example 12 provides the one or more non-transitory computer-readable media of example 11, where generating the virtual scene includes accessing a virtual environment; and generating the virtual scene by modifying the virtual environment to include the virtual representation.

Example 13 provides the one or more non-transitory computer-readable media of example 12, where the operations further include modifying one or more operational behaviors of the vehicle in the real-world environment based on the virtual scene.

Example 14 provides the one or more non-transitory computer-readable media of example 11, where modifying the one or more operational behaviors of the vehicle in the real-world environment based on the virtual scene includes changing a navigation route of the vehicle in the real-world environment based on an engagement of the user with the virtual scene.

Example 15 provides the one or more non-transitory computer-readable media of example 11, where the virtual representation of the user includes a first feature and a second feature, and the user has the first feature but does not have the second feature.

Example 16 provides the one or more non-transitory computer-readable media of example 11, where generating the virtual scene includes detecting an activity of the user in the vehicle; generating an animation illustrating the activity of the user, where the virtual scene includes the animation.

Example 17 provides the one or more non-transitory computer-readable media of example 16, where generating the virtual scene includes generating a virtual representation of a real-world object in the real-world environment, the virtual scene including the virtual representation.

Example 18. A computer system, including a computer processor for executing computer program instructions; and one or more non-transitory computer-readable media storing computer program instructions executable by the computer processor to perform operations including: providing, to a user, a ride in a real-world environment through a vehicle, the user associated with a client device; generating a virtual scene based on the ride of the user in the vehicle, the virtual scene including a virtual representation of the user or the vehicle; and sending the virtual scene to the client device, the client device configured to display the virtual scene to the user.

Example 19 provides the computer system of example 18, where generating the virtual scene includes detecting an activity of the user in the vehicle; generating an animation illustrating the activity of the user, where the virtual scene includes the animation.

Example 20 provides the computer system of example 18, where generating the virtual scene includes generating a virtual representation of a real-world object in the real-world environment, the virtual scene including the virtual representation.

Example 21 provides a method, including providing, to a user, a ride in a real-world environment through a vehicle, the user associated with a client device; detecting an interaction between the user and a person outside the vehicle; generating a virtual scene based on the interaction; and sending the virtual scene to the client device, the client device configured to display the virtual scene to the user.

Example 22 provides the method of example 21, where generating the virtual scene includes generating a virtual representation of the user, the vehicle, or the person, where the virtual scene includes the virtual representation.

Example 23 provides the method of example 22, where generating the virtual representation of the user includes detecting a gesture of the user; and generating an animation illustrating the gesture of the user, where the virtual representation includes the animation.

Example 24 provides the method of example 21, where generating the virtual scene includes generating a virtual representation of a real-world object in the real-world environment, the virtual scene including the virtual representation.

Example 25 provides the method of example 24, where the real-world object is an additional vehicle operating in the real-world environment, and the person has a ride in the additional vehicle.

Example 26 provides the method of example 24, where generating the virtual scene includes generating an augmentation object, where the augmentation object represents a class of objects that is absent in the real-world environment, and the virtual scene includes the augmentation object.

Example 27 provides the method of example 26, where the interaction includes a conversation between the user and the person, and generating the augmentation object includes generating the augmentation object based on information in the conversation.

Example 28 provides the method of example 21, further including identifying a location based on the interaction; and modifying a navigation route of the vehicle based on the location.

Example 29 provides the method of example 21, further including modifying a setting of a component of the vehicle based on the interaction.

Example 30 provides the method of example 21, where the interaction is conducted through the client device.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

1. A method, comprising:
providing, to a user, a ride in a real-world environment through a vehicle, the user associated with a client device;
generating a virtual scene based on the ride of the user in the vehicle, the virtual scene comprising a virtual representation of the user, wherein generating the virtual scene comprises:
detecting an activity of the user in the vehicle,
generating an animation illustrating the activity of the user,
wherein the virtual scene includes the animation; and
sending the virtual scene to the client device, the client device to display the virtual scene to the user.

2. The method of claim 1, wherein generating the virtual scene comprises:
accessing a virtual environment; and
generating the virtual scene by modifying the virtual environment to include the virtual representation.

3. The method of claim 1, further comprising:
modifying one or more operational behaviors of the vehicle in the real-world environment based on the virtual scene.

4. The method of claim 1, further comprising:
modifying a real-world object outside the vehicle based on the virtual scene.

5. The method of claim 1, wherein generating the virtual scene comprises:
generating a first virtual representation of the user; and
generating a second virtual representation of the vehicle,
wherein the virtual scene includes the first virtual representation and the second virtual representation, and a ratio of a size of the first virtual representation to a size of the second virtual representation is different from a ratio of a size of the user to a size of the vehicle.

6. The method of claim 1, wherein the virtual representation of the user includes a feature of the user and a feature absent from the user.

7. (canceled)

8. The method of claim 1, wherein generating the virtual scene comprises:
generating a virtual representation of a real-world object in the real-world environment, the virtual scene including the virtual representation.

9. The method of claim 1, wherein generating the virtual scene comprises:
generating an augmentation object, wherein the augmentation object represents a class of objects that is absent in the real-world environment, and the virtual scene includes the augmentation object.

10. The method of claim 1, wherein generating a virtual scene comprises:
generating a virtual object based on one or more operational behaviors of the vehicle.

11. One or more non-transitory computer-readable media storing instructions executable to perform operations, the operations comprising:
providing, to a user, a ride in a real-world environment through a vehicle, the user associated with a client device;
generating a virtual scene based on the ride of the user in the vehicle, the virtual scene comprising a virtual representation of the user or the vehicle, wherein generating the virtual scene comprises:
detecting an activity of the user in the vehicle,
generating an animation illustrating the activity of the user,
wherein the virtual scene includes the animation; and
sending the virtual scene to the client device, the client device configured to display the virtual scene to the user.

12. The one or more non-transitory computer-readable media of claim 11, wherein generating the virtual scene comprises:
accessing a virtual environment; and
generating the virtual scene by modifying the virtual environment to include the virtual representation.

13. The one or more non-transitory computer-readable media of claim 11, wherein the operations further comprise:
modifying one or more operational behaviors of the vehicle in the real-world environment based on the virtual scene.

14. The one or more non-transitory computer-readable media of claim 13, wherein modifying the one or more operational behaviors of the vehicle in the real-world environment based on the virtual scene comprises:
changing a navigation route of the vehicle in the real-world environment based on an engagement of the user with the virtual scene.

15. The one or more non-transitory computer-readable media of claim 11, wherein the virtual representation of the user includes a first feature and a second feature, and the user has the first feature but does not have the second feature.

16. (canceled)

17. The one or more non-transitory computer-readable media of claim 16, wherein generating the virtual scene comprises:
generating a virtual representation of a real-world object in the real-world environment, the virtual scene including the virtual representation.

18. A computer system, comprising:
a computer processor for executing computer program instructions; and
one or more non-transitory computer-readable media storing computer program instructions executable by the computer processor to perform operations comprising:
providing, to a user, a ride in a real-world environment through a vehicle, the user associated with a client device;
generating a virtual scene based on the ride of the user in the vehicle, the virtual scene comprising a virtual representation of the user or the vehicle, wherein
generating the virtual scene comprises:
detecting an activity of the user in the vehicle,
generating an animation illustrating the activity of the user,
wherein the virtual scene includes the animation; and
sending the virtual scene to the client device, the client device configured to display the virtual scene to the user.

19. (canceled)

20. The computer system of claim 18, wherein generating the virtual scene comprises:
generating a virtual representation of a real-world object in the real-world environment, the virtual scene including the virtual representation.
